(19) United States
(12) Patent Application Publication
(10) Pub. No.: US 2008/0116259 A1
(43) Pub. Date: May 22, 2008

(54) NON-CASH MEDIA CARD AND THE PROCESS FOR DISPENSING FROM AUTOMATED TELLER

(76) Inventor: STEPHEN LLOYD OBERAN, SALEM, OR (US)

Correspondence Address: DYKAS, SHAVER & NIPPER, LLP, P.O. BOX 877, BOISE, ID, 83701-0877, US

(21) Appl. No.: 11/553,119

(22) Filed: Oct. 26, 2006

(51) Int. Cl. G06K 5/00; G07F 19/00

(52) U.S. Cl. 235/380; 235/379

(57) ABSTRACT

A non-cash media card which is dispensable through automated teller machines (ATM's), with the card having information which identifies a particular customer and the particular transaction by which the card was purchased. The invention is also a process for dispensing the non-cash media card from an automated teller machine, by which a non-cash media card is dispensed through the same mechanism as cash is dispensed, and the ATM machine is configured to embed the purchaser and transaction specific information on the card, and read the information to verify it.

### FIELD OF THE INVENTION

The present invention generally relates to non-cash media which is dispensed to a user, and more particularly to a non-cash media card which has value, and which is dispensed to a user through an automatic teller machine, and which is identified by a bar code.

### BACKGROUND OF THE INVENTION

Automated teller machines (ATM's) were introduced in the mid 70's. These are machines which dispense cash to a user, typically after the user inserts a card with electronically encoded information, such as name and account number. The value of the cash dispensed is deducted from one of the user's bank accounts and shows up on his bank statement. Currently, ATM's can be found in the lobbies of banks, in drive-though installations, in malls, in gas stations, in grocery stores, in airports, and in any place where a customer may need to obtain cash.

It is common that ATM's also dispense certain non-cash documents, such as receipts, or information about a client's account balance. These documents are printed within the machine upon demand, and are typically produced and presented through a separate delivery slot than that through which the cash is presented to customers.

There are also specialized non-ATM machines presently available for use by consumers which dispenses such objects as stamps, or in other configurations, phone cards which entitle the user to a certain monetary value of phone transactions. These machines are configured to dispense particular items, either stamps, phone cards, or other types of output. Because of their specialized function, it is impractical to offer to the customer a wide selection of cards dispensed from these machines, nor is cash dispensed from an ATM machine which has value to the user and which is selectable by the user through an ATM interface, and which has an identification code added to it to link it to the particular purchaser of that card. Cards which may be dispensed and which have value could include admission tickets to events or locations, cards with encoded memories, such as phone cards or gas cards, cards with computer chips with encoded memory, collectable cards, cards with punch outs for goods or services, bar codes, cards redeemable for goods and services, or any other card-like instrument which has value to the consumer. To be dispensable from ATM machines, the card would have dimensions and characteristics which correspond to the cash dispensing cassette parameters of the ATM machine. From such an ATM dispensable card, one configuration of the card could contain a credit-card size card which could be removable from the ATM dispensable card. The credit-card size card could be a pass to an event, or contain encoded memory information, or be any of the previously listed embodiments of the card. If it contained encoded memory information, this card could be updated with new memory information, which could augment the value remaining on the card. Since the dispensed card could be the size of the currency dispensed by that particular ATM machine, and a smaller card would be removable from the currency-sized card, the dispensable card presents the opportunity for advertising, instructions, or other information to be presented to the user.

Accordingly, this invention provides a non-cash media card for use in ATM machines which is dispensable by the same apparatus which dispenses cash from ATM machines, in other words a cash dispensing cassette of the ATM, with the card having an identification that is specific to the purchaser, which can be in the form of a bar code. Another object of the invention is to provide a process for dispensing the non-cash media cards from an ATM machine through the same apparatus which dispenses cash.

Additional objects, advantages and novel features of the invention will be set forth in part in the description as follows, and in part will become apparent to those skilled in the art upon examination of the following, or may be learned by practice of the invention. The objects and advantages of the invention may be realized and attained by means of the instrumentalities and combinations particularly pointed out in the appended claims.

### SUMMARY OF THE INVENTION

According to the present invention, the foregoing and other objects and advantages are obtained by a non-cash media card for use in an automatic teller machine (ATM). The ATM would be configured for use with a selected currency, with a number of cassettes for holding bills of different denominations of that currency. Since the currency of different nations is of different dimensions, ATM machines are made which process currency of a number of dimensions. However, no ATM machine is made which can process and dispense a credit-card sized card of 2″×3″. This size of card is desirable because the purchaser can carry such a card in the same way he carries credit cards, in a wallet, purse, or pocket. The non-cash media card would be configured to correspond to the requirements of any of these ATM machines. The non-cash media card is a card which is dispensed by the ATM, and which has the same dimensional tolerances for the currency dispensed by the ATM, and which has the capability of being associated with a particular transaction with a user, as by a bar code specific to each card. The non-cash media card has a value to the user or can be used by the user in exchange for goods and services.

The characteristics of the non-cash media card will be similar to the selected undamaged currency which the ATM processes in terms of the side edge characteristics, the flex and stiffness tolerances, the roughness tolerances, the thickness tolerances, the weight tolerances, the tear tolerances, the length and width tolerances, the porosity tolerances, and the contrast ratio opacity tolerance. Each of these parameters are important in the cash for interacting with the machinery of the ATM, and for verification of authenticity.

The non-cash media card could be a ticket allowing entry to an event or a location. It could also be a collectable card, such as a card for a sports figure or to commemorate an event. If the card involves stored memory, each subsequent transaction could reduce the remaining value chargeable on the card. Some uses of this card could be for telephone charges or for gas purchases, but obviously could be utilized for any purchase for which a card reader is available. For a non-cash media card as described above which contains a separable portion with information storage media, the value chargeable to the card can be augmented by a subsequent transaction in an appropriate machine or by the user at the ATM machine by making a phone call, by face-to-face transaction, or to other industry acceptable ways of augmenting value. The non-cash media card of the invention is imprintable with information about the purchaser and about the transaction of buying the card. Due to this information, the card can be tracked as it is used, and value can be uploaded to the card subsequent to the original transaction. The imprinting of the information can be as information stored on the memory media of the card, and can be by a bar code imprinted on the card. The bar code information can be preprinted on all the cards loaded into the ATM machine, or can be printed on each card as it is purchased and dispensed. If the bar code information is preprinted, the transaction information would be sent from the ATM to a computing center, and the purchaser and transaction information would be associated with the bar code at that point. Bar code or other identifying information can be imprinted in a printing process with ink, by a laser marking process, or other means of making a visible symbol. Bar code type information can also be imprinted by electronic means, as electronic data on a magnetic, optical or other storage medium.

Another way that information can be associated with the transaction is by the use of RFID, or Radio Frequency Identification. An RFID tag is an object that can be attached to or incorporated into a product, animal, or person for the purpose of identification using radio waves. Chip-based RFID tags contain silicon chips and antennas. Passive tags require no internal power source, whereas active tags require a power source. It has been dubbed the “contactless” card or system for doing what the other cards do, but would be encoded with the same information as is conveyed in a bar-code. A file would be set up on the card to be attached to a unique specific frequency and every time the non-cash media card is used with that frequency, the user would be identified.

The invention is also a process for dispensing a non-cash media card which is associated with a particular transaction, from an ATM machine through the same mechanism through which the cash is dispensed.

The invention is also a process for dispensing a non-cash media card which is associated with a particular transaction, from an ATM machine through the same mechanism through which cash is dispensed.

The non-cash media card and the process of the invention thus provides a card and a process for dispensing the card through an ATM machine and associating that card to an individual purchaser and the original transaction. This provides a secure environment for dispensing a variety of value added cards which is not presently available. The secure environment has the unexpected benefit of reducing shrinkage due to losses from theft. This is also an unexpected use of an ATM machine. This also presents an opportunity for companies to advertise goods or services on the card, and allows a seller of goods or services to sell a customer a non-cash media card which is redeemable at a later date with or without the use of a magnetic card reader or other value added storage devices.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects, all without departing from the invention. Accordingly, the description is to be regarded as illustrative in natures, and not as restrictive.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The preferred embodiment of the invention is a non-cash media card which is dispensed from an automated teller machine (ATM), and in which the card can be associated with an individual purchaser and transaction. This may be accomplished in various ways, each with a different level of complexity. The first level would be that in which the alignment of the bar codes represent specific information held in a database on a server or other means. The second level of media storage would be exemplified by mag-stripes and holograms where embedded information is actually added to the card (whether magnetic, optical, RFID, or other storage means) that also can be more specific, but also refer back to another database or file held on a server or other. The third level would be the chip-set where an actual computer chip or RFID chip would hold real information in its own data file, yet can also be used to access data in a data file on an independent server.

This may be accomplished by a card preprinted with a bar code, in which the ATM dispensing the card would be configured to read the bar code as the card is dispensed. The ATM of this system could also be configured to encode the card with information specific to the purchaser and a particular transaction. This could be by an imprinting function in the ATM, or by a memory updating function by which the purchaser and transaction specific information is encoded onto the storage memory of the card.

This card is preferably made from any number of different plastic materials, polyester (which does not leave a track mark), or which any number of formulations would be appropriate. The dimensions and tolerances of the card are such that it is compatible with the cash handling apparatus of an ATM machine. Specifically, the card is 8 to 30 mils thick. For an ATM machine which is configured to handle United States currency, the ATM dispensable card is 65 to 95 millimeters (2″) in width. It is from 120 to 170 millimeters in length. Its weight is 65 to 95 grams per square meters. Its bendsden roughness is from 200 to 1200 ml per minute. Its taber stiffness (in the cross direction) is 0.8 to 2.4 (machined direction) is a minimum of 230 mN. Its bendsden velocity is 150 mils per minute. Its single tear (machined direction) is a minimum of 230 mN. Its single tear (cross direction) is a minimum of 270 mN. Its contrast ratio opacity (including inking) is a minimum of 79%.

While maintaining these physical characteristics, the non-cash media card can be configured to serve as an admission ticket to events or locations. It can also be configured to serve as an admission ticket to events or locations. It can also be configured to carry an image which makes the card collectible, such as an image of a sports figure. The card can be configured with punch-outs for goods or services, in which a region of the card is removed to indicate that goods have been received or a service has been performed. When all of the punch-outs of the cards are utilized, the user would have to buy a new card with punch-outs. The cards themselves may also be redeemable for goods or services, such as a car wash. A carpet cleaning, a hot air balloon ride, or any number of goods or services. The card could also have regions with encoded memory on which subsequent transactions would be recorded to diminish or augment the stored value on the card. The memory could be in the form of a magnetic strip or strips, computer chips, RFID chips, bar codes, holograms, optical recognition or other means of storing data.

In another preferred embodiment of the invention, the non-cash media card is configured to be within the dimensions as the currency being handled by an ATM machine, is of the same tolerances as noted above, and the possibility of having a removable portion which is the size of a conventional credit card. This removable portion can be configured as in the embodiment described above, to act as a pass to events, or as a collectible, and to carry stored information in a memory storage device. In both of these configurations, the non-cash media card can be printed to display promotional information in addition to serving the purpose for which the card was purchased.

Each card will have an identification element for associating the card to a particular purchaser and a particular transaction. The identification element on the card may be on the front or back of the card, and may be on both the removable portion of the card, and the larger card which surrounds the removable card.

A convenient and easy way to integrate bar codes or their equivalent into the card dispensing system is to incorporate a bar code system with the card and/or the card dispensing ATM. In one configuration, as the card is first picked from the ATM cassette (depending on the type of cassette), it will pass by a reader or scanner that reads the bar code on the card. Some cassettes have a partially opened portion as they are inserted into the ATM as a part of their interfacing mechanism which would allow for the bar code to be visible as the next to be dispensed. As it is picked up by the dispensing mechanism and travels through the dispensing channel, most have a place where they are once again checked for any details or problems before being presented at the outlet of the ATM. At the point of final checking, the ATM has a second reader for final verification of the bar code.

The information relating to the user and the transaction is stored in the memory of the ATM like any other cash transaction, plus it is sent to the processor. The system will have the capability of tracking the card and linking it to the account that purchased it from the ATM. When the card is purchased it is by way of credit card, ATM card or Debit card where all of the account holder's information is accessed during the transaction. This allows us to identify which card(s) were purchased by what type of payment instrument, and who purchased the card, for tracking purposes and for the next step in allowing for a flexible load to the card.

Flexible load means the customers may now tell the ATM how much money he wants on this card he just purchased verses having to place pre-denominated cards in the ATM only.

The bar code is purely for tracking the card for inventory control AND to then be able to link that card (file and number held on the server of the card issuer) to the purchaser. Linking the card to a particular purchaser allows the purchaser to reload the value on the card, or at the time of purchase to place an amount on the card of his choosing rather than buying a pre-denominated value. It also has importance in creating a classification of the type of transaction as determined by VISA or MC and the processors. We want the ability to identify this transaction as a banking or EFT transaction verses a PO (point of sale) transaction only. An EFT transaction as a banking or EFT transaction verses a POS (point of sale) transaction only. An EFT transaction is a transfer of funds, other than a transaction originated by check, draft, or similar paper instrument, which is initiated through an electronic terminal, telephone instrument, or computer or magnetic tape to authorize a financial institution to debit or credit an account.

POS (stands for POINT OF SALE) is an electronic payment system in a merchant's location where consumers pay for retail goods and services, through the use of credit cards or debit cards that directly access and deduct funds from the customer's checking account.

When someone comes to the ATM for any transaction, whatever card they use to initiate the transaction will identify the person at the ATM and their banking account or at least the account linked to the card they choose to use to initiate the transaction. When they are identified, their profile will contain all their account information on the bank's network and servers. This is the means in which the plastic card is linked to the customer, account numbers, and PIN numbers so they can be verified and the transaction completed.

With the customer now verified and having his profile accessed, the newly dispensed non-cash media card can now be linked to his profile like any other card so if he chooses later to reload (adding more to the card), he can do so at the ATM or online. It also will give the system a real time ability, so if he chooses to place more funds (beyond the predenominated value) on the card at the time of purchase he can elect to do so with money from either his checking, saving account or credit account. Now this card belongs to him like his VISA debit of ATM card, and he can add more money to the account that he has just opened, as if transferring funds from one account to another.

The bar code identifies the card for inventory control and then assigns the card to the purchaser. The bar code is the link to the server file of the card issuer only for that card. Once it is identified and tagged to the profile of the purchaser it now becomes part of his new profile. We will know when it was purchased, where, by what profile and if any funds were added to it beyond the predenominated funds. The system will also be able to give the option of offering a card with no predenominated funds and let the customer determine how much he would like on this gift or stored value card.

In another preferred embodiment of the invention, the invention is a process for dispensing a non-cash media card from an ATM machine. The non-cash media card is a card as described above, which is selected by a user through the ATM interface, and dispensed from the ATM through the same apparatus, currency cassettes, as that which is sued to dispense cash.

While there is shown and described the present preferred embodiment of the invention, it is to be distinctly understood that this invention is not limited thereto but may be variously embodied to practice within the scope of the following claims.

1. A non-cash media card for use in an automated teller machine configured for use with a selected currency, comprising:
a non-cash media card which includes a credit card size separable portion and information and storage media with information encoded on the information storage media which a user utilizes for subsequent transactions, in which said non-cash media card is configured for storage in a currency dispensing cassette of an automated teller machine, and dispensing by said automated teller machine, and which has the same dimensional tolerances as the currency dispensed by the automated teller machine, and which has value to the user and is used by the user in exchange for goods and services, and which includes a capability to receive a card identification code encoded by said automated transaction machine when said non-cash media card has been purchased by a user and before said non-cash media card is dispensed, with said card identification code configured to associate said user to said non-cash media card.

2. (canceled)

3. (canceled)

4. (canceled)

5. (canceled)

6. The non-cash media card of claim 1 in which said information code includes information specific to a specific purchaser.

7. The non-cash media card of claim 1 in which said non-cash media card is configured to be encoded with identification code information and as each card is dispensed with said identification code being readable by said automated teller machine as said card is dispensed with said identification code being associated with information specific to said transaction.

8. (canceled)

9. A non-cash media card dispensing and tracking system, the system comprising:
an ATM machine configured to dispense a selected currency and non-cash media cards with the same physical characteristics as said selected currency, with said ATM being configured to identify a user upon initiation of a transaction, dispense a non-cash media card, read a card identification code on said card as it is dispensed, and to send information about said user and said card to a computing center for associating said non-cash media card with said user;
a plurality of non-cash media cards, with each card comprising a credit card size separable portion and information and storage media with information encoded on the information storage media which a user utilizes for subsequent transactions, in which said non-cash media card is configured for storage in a currency dispensing cassette of said ATM, and for dispensing by said ATM, with said non-cash media card having the same dimensional tolerances as the currency dispensed by the automated teller machine, and which has value to the user and is used by the user in exchange for goods and services, and which includes an identification code identifying an individual card encoded on said card; and
a computing center with a database of user profiles for associating said card identification code with an identified user, and for recording transactions with said card subsequent to issuance of said card from said ATM machine.

10. The card dispensing system of claim 9 in which said identification code of an individual card is in the form of a bar code imprinted on said non-cash media card.

11. The card dispensing system of claim 10 in which said bar code is preprinted on said non-cash media card.

12. The card dispensing system of claim 10 in which identification code is stored in said information storage media.

13. The card dispensing system of claim 10 in which said bar code is written to said non-cash media card after said card has been purchased by a purchaser by means of an ATM machine with writing capability.

14. The card dispensing system of claim 13 in which said identification code includes information specific to a specific purchaser and to a specific non-cash media card.

15. The card dispensing system of claim 13 in which said ATM is configured to print identification code information on a non-cash media card based on information input by a purchaser.

16. The card dispensing system of claim 15 in which said ATM is configured to imprint said bar code information in said information storage media of said card.

17. The card dispensing system of claim 13 in which said ATM is configured to imprint said bar code information on said card in a printing process.

18. A process for issuing and dispensing non-cash media cards from the currency cassette of an automated teller machine, and for tracking subsequent transactions made with said of non-cash media cards comprising the steps of:
initiating issuance of said non-cash media card by presenting a transaction device to an automated teller machine, said transaction device containing a first identification code readable by said automated teller machine;
reading said first identification code on said transaction device by said automated teller machine, said automated teller machine identifying, verifying, and storing information recorded in said first identification code by accessing a network containing a database storing said user's information, said automated teller machine and said network correlating said information recorded in said first identification code to said user's information; issuing of said non-cash media card to said user by said automated teller machine, said automated teller machine encoding a second identification code onto an information storage media located on said non-cash media card, said second identification code containing information needed for linking said non-cash media card to said network containing said database storing said user's information;
reading of said second identification code by said automated teller machine prior to dispensing said non-cash media card, said automated teller machine verifying said user's information encoded in said second identification code on said non-cash media card; and
dispensing said non-cash media card to said user.

19. The process for issuing and dispensing non-cash media cards from an automated teller machine within claim 18, with the step of issuing said non-cash media card further comprising assigning a non-cash media card with a predetermined value to said user.

20. The process for issuing and dispensing non-cash media cards from an automated teller machine within claim 18, with the step of issuing said non-cash media card further comprising assigning a non-cash media card to said user, said non-cash media card containing a value selected by said user at the time of issuance.

21. The process for issuing and dispensing non-cash media cards from an automated teller machine within claim 19, enabling said user to reload transaction value accessible by said non-cash media card.

22. The process for issuing and dispensing non-cash media cards from an automated teller machine within claim 20, enabling said user to reload transaction value accessible by said non-cash media card.

23. The process for issuing and dispensing non-cash media cards from an automated teller machine within claim 18, in which said network containing said database is capable of tracking the transactions in which said non-cash media cards are used and linking said transactions to said user.

24. A process for issuing and dispensing non-cash media cards from the currency cassette of an automated teller machine, and for tracking subsequent transactions made with said of non-cash media cards comprising the steps of:
initiating issuance of said non-cash media card by presenting a transaction device to an automated teller machine, said transaction device containing a first identification code readable by said automated teller machine; reading said first identification code on said transaction device by said automated teller machine, said automated teller machine identifying, verifying, and storing information recorded in said first identification code by accessing a network containing a database storing said user's information, said automated teller machine and said network correlating said information recorded in said first identification code to said user's information;
issuing of said non-cash media card to said user by said automated teller machine, said automated teller machine reading a second identification code pre-recorded on an information storage media located on said non-cash media card, said automated teller machine assigning said second identification code to said user by communicating said second identification code to said network containing said database;
reading of said second identification code by said automated teller machine prior to dispensing said non-cash media card, said automated teller machine verifying said user's information encoded in said second identification code on said non-cash media card; and
dispensing said non-cash media card to said user.

25. The process for issuing and dispensing non-cash media cards from an automated teller machine within claim 24, with the step of issuing said non-cash media card further comprising assigning a non-cash media card with a predetermined value to said user.

26. The process for issuing and dispensing non-cash media cards from an automated teller machine within claim 24, with the step of issuing said non-cash media card further comprising assigning a non-cash media card to said user, said non-cash media card containing a value selected by said user at the time of issuance.

27. The process for issuing and dispensing non-cash media cards from an automated teller machine within claim 25, enabling said user to reload transaction value accessible by said non-cash media card.

28. The process for issuing and dispensing non-cash media cards from an automated teller machine within claim 26, enabling said user to reload transaction value accessible by said non-cash media card.

29. The process for issuing and dispensing non-cash media cards from an automated teller machine within claim 24, in which said network containing said database is capable of tracking the transactions in which said non-cash media cards are used and linking said transactions to said user.
